(19) United States
(12) Patent Application Publication
(10) Pub. No.: US 2015/0072297 A1
(43) Pub. Date: Mar. 12, 2015

(54) Method for Heating an Industrial Furnace and a Heating Apparatus for Carrying Out Said Method

(71) Applicant: IPSEN, INC., Cherry Valley, IL (US)

(72) Inventors: Rolf Sarres, Oberhausen (DE); Marc Angenendt, Rees (DE)

(21) Appl. No.: 14/477,133

(22) Filed: Sep. 4, 2014

(30) Foreign Application Priority Data
Sep. 10, 2013 (DE) 10 2013 014 816.2

(51) Int. Cl. F27D 17/00; F23C 1/00; F27D 7/06

(52) U.S. Cl. CPC F27D 17/004; F27D 7/06; F23C 1/00; F27D 2007/063; F27D 2099/006
USPC 432/23; 432/198; 432/199; 431/278

(57) ABSTRACT

The invention relates to a method for heating an industrial furnace, wherein, apart from heating gas, a combustible process gas is also fed to a burner arrangement (9) of the industrial furnace for heating an interior space in the course of a heat treatment cycle. In order to optimize the use of the combustible process gas for the heating of the industrial furnace, the heat treatment cycle is split up into a plurality of process phases, wherein the supply of the process gas to the burner arrangement (9) is regulated depending on the process phase. Furthermore, the invention relates to a heating device (8) for an industrial furnace, as well as an industrial furnace that includes the heating device.

### BACKGROUND OF THE INVENTION

1. Field of the Invention

The invention relates to a method for heating an industrial furnace, wherein, apart from a heating gas, combustible process gas is also fed to a burner arrangement of the industrial furnace for heating an interior space in the course of a heat treatment cycle. Furthermore, the invention relates to a heating device for an industrial furnace, as well as to an industrial furnace that incorporates such a heating device.

2. Description of the Related Art

In industrial furnaces constituted as atmosphere heat treatment furnaces, use is usually made of process gases which serve for the protection of the surface of the batch to be treated in the given industrial furnace or for a change in the chemical composition of this charge. Process gas essentially comprises the components hydrogen, carbon monoxide and nitrogen and, in the course of the heat treatment of the introduced batch, is continuously fed to an interior space of the given industrial furnace. Subsequently, the process gas conveyed through the interior space is then usually conducted away into the open as furnace waste gas, flaring of the process gas being carried out during its exit on account of the combustibility and toxicity of the gas. However, since the calorific value of the discharged process gas is insignificant, methods in which the discharged process gas is used for the heating of the given industrial furnace are also known as an alternative to flaring.

Thus, a method for heating an industrial furnace is described in DE 197 20 620 A1, wherein, as part of a heat treatment cycle, the process gas conveyed through the interior space is at least partially fed to a burner arrangement of the industrial furnace and is used, apart from heating gas, for the operation of the burner arrangement and therefore for the heating of the industrial furnace. For this purpose, the industrial furnace comprises a heating device in which a line connects a process waste-gas outlet of the industrial furnace to the burner arrangement and thus implements the supply of the discharged process gas to the burners of the burner arrangement. Apart from a blower, various gas switching and control elements are disposed in the line.

Proceeding from the prior art described above, it is the problem of the present invention to provide a method for heating an industrial furnace, wherein combustible process gas is used as part of a heat treatment cycle for the heating of the industrial furnace only when the process gas is suitable for this in terms of its composition.

### BRIEF SUMMARY OF THE INVENTION

In accordance with a first aspect of the present invention, there is provided a method for heating an industrial furnace, wherein, apart from heating gas, combustible process gas is also fed to a burner arrangement of the industrial furnace for heating an interior space in the course of a heat treatment cycle. The method is characterised in that the heat treatment cycle is split up into a plurality of process phases and the supply of process gas to the burner arrangement is regulated depending on the process phase.

In accordance with another aspect of the present invention there is provided a heating apparatus for an industrial furnace comprising a line for connecting a process waste-gas outlet of the industrial furnace or of a temporary storage facility to a burner arrangement, wherein process gas can be fed from the process waste-gas outlet to the burner arrangement through the line. The device is characterised in that means are provided in the line by means of which a supply of the process gas to the burner arrangement can be automatically regulated depending on the process phase of a heat treating cycle.

In accordance with a further aspect of the present invention, there is provided an industrial furnace which includes a heating apparatus according to the invention as described above.

### BRIEF DESCRIPTION OF THE DRAWINGS

An advantageous embodiment of the invention, which is described below, is illustrated in the following drawings.

FIG. 1 shows a diagrammatic view of an industrial furnace, wherein a method for heating according to the invention can be carried out; and

FIG. 2 shows a diagrammatic view of a heating device used in the industrial furnace of FIG. 1.

### DETAILED DESCRIPTION

According to the invention, in a method for heating an industrial furnace, combustible process gas is also fed, apart from heating gas, to a burner arrangement heating an interior space of the industrial furnace in the course of a heat treatment cycle. For this purpose, a heating device for an industrial furnace comprises in particular a line for connecting a process waste-gas outlet of an industrial furnace or of a temporary storage facility to a burner arrangement, wherein process gas can be fed from the process waste-gas outlet to the burner arrangement via this line.

In carrying out the method of the present invention, the industrial furnace can be a batch furnace, such as a chamber furnace or a multi-purpose chamber furnace, or a continuous or semi-continuous furnace, such as a pusher-type furnace, a rotary hearth furnace, a roller hearth furnace, a conveyor belt furnace, etc. Furthermore, “heat treatment cycle” is understood to mean the entire process of treating a batch of material, typically metal work pieces, in an industrial heat treating furnace from the introduction into the industrial furnace to its removal.

The process gas fed to the burner arrangement is preferably an endothermic gas, which in particular has originally been produced in a generator from atmospheric oxygen and natural gas and has then been used in a heat treatment cycle for the surface protection of a given batch of material or for changing its chemical composition. In the same way, however, the process gas can also be hydrogen-, carbon monoxide- and nitrogen-containing process gas, which arises in the furnace through the reaction of gaseous or liquid hydrocarbons, such as natural gas, propane, methanol, acetone, etc. introduced into the heat treatment furnace.

The process gas, which is used for heating as part of the heat treatment cycle of the given industrial furnace, can have been removed either from the same industrial furnace or from one or more separate industrial furnaces in the course of heat treatment cycles taking place there. Especially in the second case, the provision of one or more temporary storage facilities is also contemplated, into which the process gas discharged from each unit is collected and then used for heating in one or more other industrial furnaces. Correspondingly, the supply line of the heating device according to the invention can either connect the process waste-gas outlet and the burner arrangement of one and the same industrial furnace or can provide a connection between the burner arrangement of the industrial furnace and the process waste-gas outlet of another industrial furnace or a temporary storage facility.

In accordance with the method of the present invention the heat treatment cycle may be carried out as a plurality of process phases and the supply of the process gas to the burner arrangement is regulated depending on the conditions of a given process phase. In other words, a heat treatment of a batch introduced into the given industrial furnace thus takes place in a plurality of process phases, wherein the supply of process gas to the burner arrangement of the industrial furnace takes place depending on the process phase taking place at the time.

In the heating apparatus according to the invention, means are provided in the line for the purpose of supplying the process gas to the burner arrangement in an automatically regulated manner that depends on the process phase conditions. Consequently, these means disposed in the line are suitable for automatically regulating a supply of the process gas depending on the process phase conditions of the heat treatment cycle.

The method according to the invention has the advantage that a supply of combustible process gas to the burner arrangement can thus be regulated without problem, in such a way that this supply is carried out in a targeted manner only in process phases in which a composition of the process gas discharged from an interior space of an industrial furnace is suitable for combustion in the burner arrangement. This is because, depending on the given process phase and also the type of industrial furnace, the composition of the process gas and therefore, its calorific value and combustion behaviour can fluctuate considerably.

Thus, the furnace waste gas discharged at the start of the heat treatment cycle is not suitable for carrying out heating, since an interior space of the given industrial furnace may be completely burnt out when there is a batch change and, as a result of this, only a small quantity of combustible process gas can be fed back to the burner arrangement. Furthermore, chemical impurities often evaporate from the surface of a newly introduced batch of material during a heating-up phase of the furnace which can contaminate the process gas before it is discharged. These impurities may be washing agent residues, the residues of cooling lubricants from the cutting or shaping production of the batch, as well as hardness protection agents, which in each case are carried onto the surface of the batch. The latter, in particular, comprise the most diverse chemical compounds and contaminate the process gas with volatile components, which would give rise to a considerable impairment of the combustion in the burner arrangement of the furnace.

If the batch introduced into the interior space of the industrial furnace is also quenched inside the furnace as part of a process phase, large quantities of hardening (quenching) oil evaporate during this quenching, which leads to sooting of the burner arrangement when the process gas is introduced therein. Through the process phase-dependent supply of process gas to a burner arrangement of an industrial furnace, the heating of an industrial furnace with the used process gas can thus be optimised over the heat treatment cycle.

It is true that process gases are also used in the case of DE 197 20 620 A1 in the operation of a burner arrangement of an industrial furnace, but the supply does not however take place depending on the process phase, so that the problems described above can occur and have a lasting effect on the operation of the burner arrangement. Furthermore, the heating device disclosed in DE 197 20 620 A1 is not suitable for automatic regulation as a function of process phases, since the gas switching and control elements of the heating device have to be operated manually according to a system of symbols. As a result, a continuous supply of waste gas discharged from the interior space would take place in the absence of manual control.

According to an embodiment of the method of this invention, at least one burner of the burner arrangement is supplied with the process gas during the step of supplying the process gas to the burner arrangement. In another embodiment according to the invention a plurality of burners are supplied with the process gas simultaneously. As a further alternative, however, a plurality of burners of the burner arrangement are supplied with the process gas individually one after the other in sequence or in groups, preferably in pairs, in a cycle during the supply of process gas to the burner arrangement, so that not all the burners supplied with the process gas are operated simultaneously, but similar to a round-the-clock actuation. In particular, this can take place when a given desired temperature has to be held during a process phase and the operation of a single burner or a few burners is sufficient for this purpose. In addition, burners to be operated conventionally with heating gas can be switched off during the supply of process gas to the burner arrangement or the operation can be carried out simultaneously with heating gas, for example in order to provide sufficient heating of the industrial furnace despite the lower calorific value of the process gas.

In a further embodiment of the method of the invention, at least one burner of the burner arrangement is supplied with heating gas as part of the heat treatment cycle and/or with process gas during the supply of process gas. At least one burner of the burner arrangement is thus configured as a so-called duplex burner, which can be operated with the heating gas and/or with the process gas. Such an embodiment has the advantage that the total number of burners to be provided can thus be kept small, since at least some of the burners otherwise regularly operated with heating gas can also be supplied and fired with the supplied process gas. In principle, it is contemplated that the given duplex burner is supplied in the regular operation only with heating gas and, during the supply of process gas, only with process gas or, during the supply of process gas, a supply to the duplex burner with a mixture of heating gas and process gas takes place.

It is a further embodiment of the method of this invention that only heating gas is fed to the burner arrangement in a first process phase of the heat treatment cycle in which the industrial furnace is charged with a work load batch and the interior space is then heated to a target temperature, whereas the process gas is fed to the burner arrangement in at least one following process phase of the heat treatment cycle in which a given process temperature is to be maintained. In a concluding process phase of the heat treatment cycle in which the batch is quenched and then removed from the industrial furnace, heating gas alone is again fed to the burner arrangement.

The first process phase is a heating-up phase or a first heating-up phase, in which a supply of process gas is not advisable on account of the impurity content of the process gas. In contrast, at least one subsequent process phase can be a second heating-up phase, in which the impurity content of the process gas is then no longer expected. Alternatively or in addition, the heat treating cycle may include one or more holding phases, in which the temperature of the interior space has to be held at the given process temperature. These phases may possibly also be interrupted by an intermediate cooling phase, in which a supply of process gas is either permitted or prevented. Depending on the assignment of the individual process phases, the target temperature of the first process phase can correspond to or also lie below the process temperature of the following process phase.

Within the scope of the invention, however, any number of successive process phases could be used, wherein a supply of process gas to the burner arrangement is permitted or prevented in each individual process phase considered by itself.

In accordance with another embodiment of the method of the invention, the process gas is conveyed via a furnace pressure-dependent frequency-regulated blower when the process gas is being supplied to the burner arrangement. On the one hand, a sufficient pressure build-up before the at least one burner of the burner arrangement can thus be created and, on the other hand, it is possible to prevent the removal of an excessively large quantity of process gas from an interior space of the furnace which could cause an under-pressure condition to occur in the interior space and therefore, the risk of the penetration of ambient air into the interior space arising.

According to an advantageous embodiment of the heating device according to the invention, the means provided in the process gas line comprises at least one valve, which is preferably configured as a solenoid valve. Furthermore, the furnace pressure-dependent frequency-regulated blower is preferably disposed downstream of a valve, so that on the one hand a supply of process gas can be completely prevented by the at least one valve, but at the same time a quantity regulation is possible by means of the blower.

Furthermore, when the burner arrangement is connected to the process waste-gas outlet of an industrial furnace, a safety burner with a pressure relief valve is assigned to this process waste-gas outlet, by means of which pressure relief valve the process gas can be flared when the supply to the burner arrangement is absent or also when there is an excessively high pressure. Furthermore, the burners of the burner arrangement are preferably constructed as radiant tube burners, the radiant tubes of which are installed in the interior space of the industrial furnace. Finally, the heating device according to the invention can be present as a fixed component of an industrial furnace or can also be a unit that can be retrofitted in an industrial furnace.

The invention is not limited to the stated combination of the features of the coordinated claims or of the claims dependent thereon. Possibilities also arise for combining individual features with one another, insofar as they emerge from the claims, the following description of a preferred embodiment, or directly from the drawings. The reference of the claims to the drawings by the use of reference numbers is not intended to restrict the scope of protection of the claims.

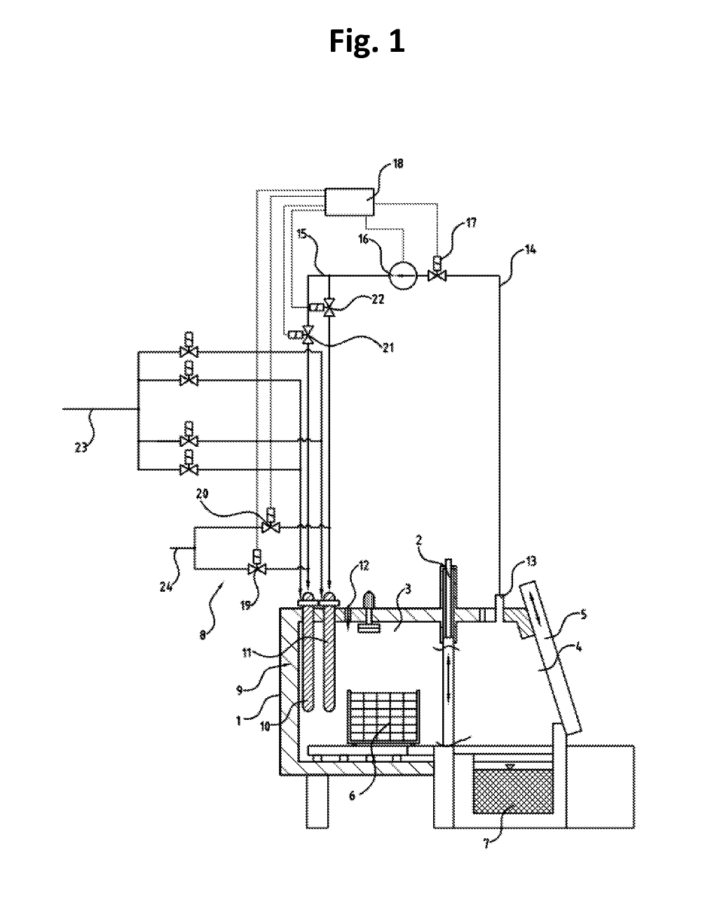

A diagrammatic view of an industrial furnace emerges is shown in FIG. 1, which in the present case is configured as a multi-purpose chamber furnace. The industrial furnace comprises a housing 1, the interior space of which is split up by a slide gate 2 into a main chamber 3 and a pre-chamber 4 and in which a batch 6 of metal work pieces to be heat-treated can be received via a charging gate 5 provided in the region of pre-chamber 4. Also provided beneath pre-chamber 4 is a quenching bath 7, into which batch 6 when transferred into pre-chamber 4 can be immersed.

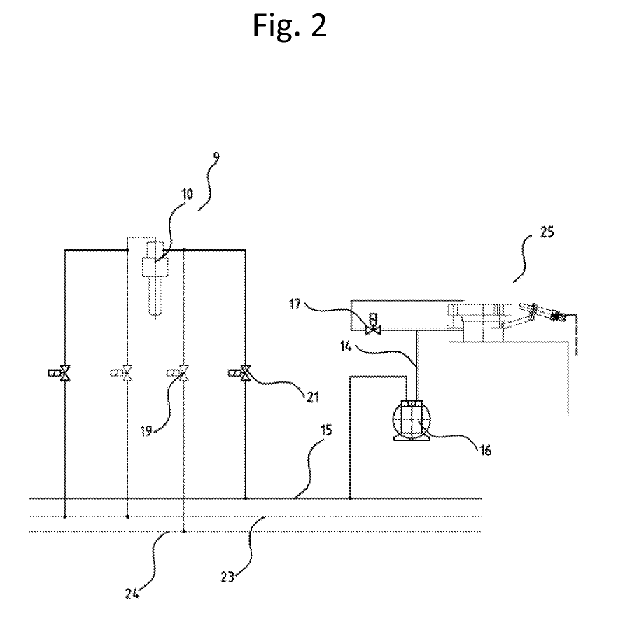

During a heat treatment cycle of batch 6, the interior space of housing 1 is heated by means of a heating device 8, which is also represented diagrammatically in FIG. 2 separately. This heating device 8 comprises a burner arrangement 9 with a plurality of burners 10 and 11, which are each preferably radiant tube burners and whereof only burner 10 can be seen in FIG. 2. In a conventional operation of burner arrangement 9, burners 10 and 11 are each supplied with heating gas, preferably in the form of natural gas, and air and they heat up the interior space of main chamber 3 as a result of the heat arising during the combustion of the heating gas.

During the heat treatment cycle of batch 6, a process gas is fed to the interior space of housing 1 in order to protect the surface of batch 6 during the heat treatment and, if need be, also to bring about a change in the chemical composition of batch 6. This process gas, which is preferably endothermic gas, is fed via a gas inlet 12 to the interior space in the region of main chamber 3 and then flows through main chamber 3, where it comes into contact with batch 6. Proceeding from main chamber 3, the process gas then flows into pre-chamber 4 and is discharged from there via a process waste-gas outlet 13.

As can be seen in particular in FIG. 1, process waste-gas outlet 13 is connected via a line 14 to burner arrangement 9, so that the discharged process gas can be fed to burner arrangement 9 and thereby to burners 10 and 11. Line 14 supplies, as can be seen in FIG. 2, a ring line 15 for process gas, from which the process gas can be fed to individual burners 10 and 11. The supply to ring line 15 takes place by means of a frequency-regulated blower 16 which is provided in line 14 and which is regulated as a function of a pressure in the interior space of housing 1.

As a particular feature, however, the discharged process gas is not conveyed continuously to burner arrangement 9, but rather the supplying of the process gas is carried out depending on process phases of the heat treatment cycle of batch 6. For this purpose, a solenoid valve 17 is disposed in line 14 upstream of blower 16, said solenoid valve being able to be actuated by a higher-order furnace controller 18, which also controls further solenoid valves 19 to 22 in the heating device 8. Consequently, furnace controller 18 can, on the one hand, generally control a supply of process gas discharged via process waste-gas outlet 13 to heating device 8 and from there to burner arrangement 9, and then, inside heating device 8, can supply by means of solenoid valves 19 to 22 either heating gas and air or process gas and air or also with the two gas variants to burners 10 and 11.

In the present case, burners 10 and 11 may be so-called duplex burners, which can be operated either with heating gas or with process gas, and also with a mixture of those two types of gases. In order to enable combustion during operation using process gas or a mixture of the process gas with the heating gas, the process gas discharged via the process waste-gas outlet 13 is thoroughly mixed with air from a ring line 23 before being fed to burners 10 and 11. Ring line 23 also supplies air to burners 10 and 11 during their operation by means of heating gas, heating gas also being fed in this case from a ring line 24 by opening corresponding valves 19 and 20. A flaring device 25, shown in FIG. 2, is connected to process waste-gas outlet 13 such that the discharged process gas can be flared (burned off) when solenoid valve 17 is closed. Such condition occurs after a certain (predetermined) gas pressure is reached in the interior space of housing 1.

The heating of the industrial furnace can be carried out as follows, as part of a heat treatment cycle of batch 6. In a first process phase the batch 6 is introduced via the charging gate 5 into the interior space of housing 1 and is subsequently moved into main chamber 3, and the interior space is then heated to a target temperature, burners 10 and 11 are supplied only with heating gas and air, whilst any process gas discharged via a process waste-gas outlet 13 is burned off by means of flaring device 25. The underlying reason for this step is that when charging gate 5 is opened for a certain amount of time, little or no combustible process gas can be fed to burner arrangement 9 because the interior space of housing 1 is completely burned out while gate 5 is open. Furthermore, contamination of the process gas with impurities evaporating from the surface of batch 6 can occur during the heating to the target temperature, which in the case of a supply to burner arrangement 9 could possibly result in it being adversely affected.

If heating has been carried out to the target temperature which corresponds to the process temperature of a subsequent process phase in the form of a holding phase, the supply of gas to burners 10 and 11 is switched by means of furnace controller 18 such that solenoid valve 17 is opened and the speed of blower 16 is regulated as a function of the furnace pressure. Depending on how much energy is required to maintain the process temperature, both burners 10 and 11 can be operated with process gas or can also be supplied individually or one after another (alternately) with the process gas. It is also contemplated that one of burners 10 and 11 can be operated regularly or not at all with the heating gas. Furthermore, as already mentioned above, a mixture of the heating gas with the mixture of process gas and air is considered as an operating condition of the burner arrangement 9. A suitable control operation can be implemented by furnace controller 18 by appropriate triggering of solenoid valves 19 to 22.

In a last process phase, in which batch 6 is transferred out of main chamber 3 into the region of pre-chamber 4 and is then lowered into quenching bath 7, the supply of process gas to heating device 8 is then prevented again by the closing of solenoid valve 17, because during the quenching hardening oil is evaporated which, if supplied to burners 10 and 11, would produce undesirable sooting. Batch 6 is then removed via charging gate 5 and, if appropriate, a new batch is fed in. Depending on the heat treatment cycle, further process phases can be provided between the holding phase and this last process phase, in which further process phases a supply of process gas to heating device 8 is then either carried out or prevented.

The use of discharged, combustible process gas for heating an industrial furnace can be optimised by means of the method and device according to the invention for heating the industrial furnace.

### LIST OF REFERENCE NUMBERS

1 housing
2 slide gate
3 main chamber
4 pre-chamber
5 charging gate
6 batch
7 quenching bath
8 heating device
9 burner arrangement
10 burner
11 burner
12 gas inlet
13 process waste-gas outlet
14 line
15 ring line for process waste gas
16 blower
17 solenoid valve
18 furnace control
19 solenoid valve
20 solenoid valve
21 solenoid valve
22 solenoid valve
23 ring line for air
24 ring line for heating gas
25 flaring device

1. A method for heating an industrial heat treating furnace comprising the steps of supplying a combustible process gas to a burner arrangement (9) of the industrial heat treating furnace and burning the combustible process gas to produce heating of an interior space of the industrial heat treating furnace during a heat treatment cycle, wherein the heat treatment cycle is divided into a plurality of process phases and the step of supplying the combustible process gas is regulated according to conditions in the industrial heat treating furnace during each of the process phases.

2. The method according to claim 1, wherein during the step of supplying the process gas to the burner arrangement (9), at least one burner (10, 11) of the burner arrangement (9) is supplied with the process gas.

3. The method according to claim 2, wherein during the step of supplying the process gas to the burner arrangement (9), a plurality of burners (10, 11) of the burner arrangement (9) are supplied with the process gas individually one after the other or in groups during a heat treatment cycle.

4. The method according to claim 3, wherein during the step of supplying the process gas to the burner arrangement (9), the plurality of burners (10, 11) of the burner arrangement (9) are supplied with the process gas in pairs.

5. The method according to claim 1, comprising the step of supplying heating gas to at least one burner (10, 11) of the burner arrangement (9) as part of the heat treatment cycle and/or with the process gas.

6. The method according to claim 1 comprising the steps of:
supplying only heating gas to the burner arrangement (9) in a first process phase of the heat treatment cycle in which the industrial furnace is charged with a batch (6) and the interior space is then heated to a target temperature,
performing the step of supplying the process gas to the burner arrangement (9) in at least one following process phase of the heat treatment cycle in which heating-up is continued from the target temperature to a process holding temperature or in which the furnace temperature is held at the given process temperature, and then
supplying heating gas alone to the burner arrangement in a concluding process phase of the heat treatment cycle in which the batch (6) is quenched and then removed from the industrial furnace.

7. The method according to claim 1, wherein the step of supplying the combustible process gas comprises the step of conveying the combustible process gas via a furnace pressure-dependent frequency-regulated blower (16).

8. A heating apparatus (8) for an industrial furnace comprising:
a gas line (14) connected to a process waste-gas outlet (13) of an industrial furnace or to a temporary process gas storage facility and to a burner arrangement (9) whereby a process gas can be conveyed from the process waste-gas outlet (13) or the temporary storage facility to the burner arrangement (9); and
a gas flow control apparatus connected to the gas line (14) by which flow of the process gas to the burner arrangement (9) can be regulated depending on a process phase during a heat treatment cycle performed in the industrial furnace.

9. The heating apparatus according to claim 8 wherein the gas flow control apparatus comprises at least one valve (17).

10. The heating apparatus according to claim 9 wherein the valve (17) is a solenoid valve and the gas flow control apparatus comprises a controller (18) connected to the solenoid valve for actuating the solenoid valve.

11. The heating apparatus according to claim 9 further comprising a variable speed blower (16) provided in the line (14) downstream of the valve (17).

12. The heating apparatus according to claim 11 wherein the valve (17) is a solenoid valve and the gas flow control apparatus comprises a controller (18) connected to the solenoid valve for actuating the solenoid valve and connected to the variable speed blower (16) for adjusting the speed of the blower in response to the gas pressure inside the industrial furnace.

13. An industrial furnace comprising:
a housing (1) that defines a main chamber (3) and a pre-chamber (4);
a process-waste gas outlet (13) provided in the housing (1) so as to provide a gas flow channel from the pre-chamber (4) through the housing; and
a heating apparatus (8) comprising:
a gas line (14) connected to the process waste-gas outlet (13) and to a burner arrangement (9) whereby a process gas can be conveyed from the process waste-gas outlet (13) to the burner arrangement (9); and
a gas flow control apparatus provided in the line (14) by which flow of the process gas to the burner arrangement (9) can be automatically regulated depending on a process phase during a heat treatment cycle performed in the industrial furnace.

14. The industrial furnace according to claim 13 wherein the burner arrangement (9) comprises at least one radiant tube burner (10, 11) that is configured as a duplex burner that can be operated with a heating gas and/or with the process gas.
